(19) United States
(12) Patent Application Publication
(10) Pub. No.: US 2007/0019908 A1
(43) Pub. Date: Jan. 25, 2007

(54) Fiber optic rotary joint with de-rotating prism

(75) Inventors: Michael Thomas O'Brien, Nova Scotia (CA); Stephen Andrew Smith, Nova Scotia (CA); James William Snow, Nova Scotia (CA)

Correspondence Address: PHILLIPS LYTLE LLP;INTELLECTUAL PROPERTY GROUP, 3400 HSBC CENTER, BUFFALO, NY, 14203-3509, US

(73) Assignee: Focal Technologies Corporation

(21) Appl. No.: 11/187,756

(22) Filed: Jul. 22, 2005

(51) Int. Cl. G02B 7/182; G02B 6/34; G02B 6/26; G02B 6/42

(52) U.S. Cl. 385/36; 359/877; 359/871; 385/31; 385/33; 385/25; 385/26

(57) ABSTRACT

A multi-channel fiber optic rotary joint (FORJ) includes an external housing, a stationary collimator array, a rotating collimator array, an all-reflective de-rotating prism and a gear ratio. The external housing contains an internal cavity having a longitudinal rotation axis. The stationary collimator array is affixed to the external housing approximate a first end of the internal cavity. The rotating collimator array is rotatably attached to the external housing approximate a second end of the cavity. The second end of the cavity is opposite the first end of the cavity. The rotating collimator array is configured to rotate about the rotation axis. The de-rotating prism is located along the rotation axis within the internal cavity between the stationary collimator array and the rotating collimator array. The prism is retained in a prism housing, which is rotatably attached to the external housing and the prism housing is configured to rotate about the rotation axis.

### BACKGROUND OF THE INVENTION

There are a number of applications for which it is desirable to transmit a plurality of optical beams across a rotating interface. In the majority of these applications, it is desirable to maintain the signal strengths with minimal variation as a function of rotation. At least one fiber optic rotary joint (FORJ) has been proposed that includes a first fixed array of optical fibers and a second array of optical fibers that rotate about an axis, which is longitudinally oriented to optical beam paths. For example, U.S. Pat. No. 4,725,116 discloses a FORJ that reflects off-axis beams onto a rotation axis, rotating the beams while on-axis, and reflecting the rotated beams off-axis to a receptor fiber in a serial fashion.

As another example, U.S. Pat. Nos. 6,301,405, 5,442,721 and 5,568,578 disclose FORJs that transmit optical beams through a Dove de-rotating prism element at one-half the rotation rate of a receive optical fiber bundle, in a parallel fashion that permits, in theory, a larger number of optical fiber paths for a given rotary joint length. However, these FORJs are wavelength-dependent and are not particularly well suited for applications in which the FORJs are subject to external pressure, such as in underwater applications.

What is needed is a fiber optic rotary joint (FORJ) that is not wavelength-dependent. It would also be desirable if the FORJ was constructed in a manner which improved the ability of the FORJ to withstand external pressure.

### SUMMARY OF THE INVENTION

A multi-channel fiber optic rotary joint (FORJ), constructed according to one embodiment of the present invention, includes an external housing, a stationary collimator array, a rotating collimator array, an all-reflective de-rotating prism and a gear ratio. The external housing contains an internal cavity having a longitudinal rotation axis. The stationary collimator array is affixed to the external housing approximate a first end of the internal cavity. The rotating collimator array is rotatably attached to the external housing approximate a second end of the cavity. The second end of the cavity is opposite the first end of the cavity. The rotating collimator array is configured to rotate about the rotation axis. The de-rotating prism is located along the rotation axis within the internal cavity between the stationary collimator array and the rotating collimator array. The prism is retained in a prism housing that is rotatably attached to the external housing and the prism housing is configured to rotate about the rotation axis. The gear ratio is rotatably attached to the external housing and causes the prism housing to rotate at a rate that is one-half a rotation rate of the rotating collimator array.

According to another aspect of the present invention, the internal cavity is filled with a liquid medium to provide for pressure compensation. According to a different aspect of the present invention, the stationary collimator array and the rotating collimator array each include a plurality of fiber optic collimator assemblies arranged in a pattern in a plane transverse to the rotation axis. Each of the assemblies include an optical fiber located parallel to and coincident with an optical axis of a collimating lens near the focal plane of the collimating lens. The optical axis of the collimating lens is oriented parallel to the rotation axis. According to a different aspect of the present invention, the de-rotating prism includes a 30°-60°-90° prism attached to a 60° equilateral prism to provide an Abbe-Konig prism. According to another aspect of the present invention, the 30°-60°-90° prism and the 60° equilateral prism are made of the same material. According to a different aspect of the present invention, opposed end surfaces of the Abbe-Konig prism are oriented at orthogonal angles to the rotation axis to present an optically flat surface at normal incidence to collimated beams provided by the fiber optic collimator assemblies.

According to a different aspect of the present invention, the de-rotating prism includes a 45°-135°-67.5°-112.5° prism separated from a 45°-67.5°-67.5° prism by a small spacing to provide a Schmidt-Pechan prism. According to another aspect of the present invention, the 45°-135°-67.5°-112.5° prism and the 45°-67.5°-67.5° prism are made of the same material. According to a different aspect of the present invention, the index of refraction of the material comprising the Schmidt-Pechan prism is sufficiently high to allow total internal reflection when the prism is immersed in a pressure-compensating liquid. According to a different aspect of the present invention, opposed end surfaces of the Schmidt-Pechan prism are oriented at orthogonal angles to the rotation axis to present an optically flat surface at normal incidence to collimated beams provided by the fiber optic collimator assemblies.

These and other features, advantages and objects of the present invention will be further understood and appreciated by those skilled in the art by reference to the following specification, claims and appended drawings.

### BRIEF DESCRIPTION OF THE DRAWINGS

FIGS. 1A and 1B depict cross-sectional views of a relevant portion of a multi channel fiber optic rotary joint (FORJ) implementing an Abbe-Konig de-rotating prism (FIG. 1A) and a Schmidt-Pechan de-rotating prism (FIG. 1B);

FIGS. 2A-2D depict an Abbe-Konig de-rotating prism at 0°, 9°, 180° and 270°, respectively;

FIG. 3 depicts a fiber optic collimator assembly, constructed according to one embodiment of the present invention;

FIG. 4 depicts a fiber optic collimator assembly, constructed according to another embodiment of the present invention;

FIG. 5A is a graph that plots effective focal length versus pitch for a commercially available GRIN lens;

FIG. 5B is a graph that depicts the relationship between length and pitch for the commercially available GRIN lens of FIG. 5A;

FIG. 5C is a graph that depicts the relationship between focal length and pitch of the commercially available GRIN lens depicted in FIGS. 5A-5B; and

FIG. 6 depicts a fiber optic collimator assembly, constructed according to yet another embodiment of the present invention.

### DETAILED DESCRIPTION OF PREFERRED EMBODIMENTS

According to one aspect of the present invention, an all-reflective de-rotating prism, e.g., an Abbe-Konig prism, is implemented within a fiber optic rotary joint (FORJ) to permit parallel transmission of a plurality of collimated optical fiber beams. In general, an Abbe-Konig de-rotating prism offers a number of advantages in the construction of a multiple channel FORJ. For example, the Abbe-Konig prism is completely reflective in nature and, as such, is insensitive to the wavelength of the optical signals that it transmits. In contrast, a length of a Dove prism, along the rotation axis, is dependent upon an index of refraction of the prism material, which is wavelength-dependent. Furthermore, an Abbe-Konig prism presents perpendicular faces to a collimated optical beam that is transmitted from an individual fiber (attached either to the stator or to the rotor) and, thus, the refraction of the beam, as the beam is transmitted through either surface of the prism, is zero, regardless of the index of refraction of the incident medium. In comparison, the refraction of a collimated beam at the surfaces of a Dove prism are dependent upon both the index of refraction of the incident medium and upon the index of refraction of the prism material, both of which are wavelength-dependent.

Additionally, FORJs that implement an Abbe-Konig prism may include one or more cavities, between the prism and the fiber collimators, that may be filled with a pressure-compensating fluid, e.g., mineral oil. The Abbe-Konig prism is also shorter, along the longitudinal rotation axis, than a Dove prism with identical area, inside which collimated beams may be de-rotated. Thus, the overall length of an FORJ may be reduced when an Abbe-Konig prism is implemented to de-rotate the optical beams. If the Abbe-Konig is constructed from common glass, e.g., BK7, which has an index of refraction approximately equal to 1.5 in the telecommunications wavelength range of 1310 nm to 1550 nm, then the optical path length within the Abbe-Konig prism is equal to the length of the Abbe-Konig prism along the rotation axis. This feature allows for optimization of the transmitted signal strength between stator and rotor collimators, located coincident to the rotation axis, to be performed prior to installation of the Abbe-Konig prism in the FORJ. Thus, an Abbe-Konig prism may subsequently be installed into the FORJ without significant change to the entire optical path length between the collimators. In comparison, the optical path length of the Dove prism is shorter than the overall length of the Dove prism and subsequent longitudinal alignment is required after insertion of a Dove prism between the collimators.

According to a different aspect of the present invention, an all-reflective de-rotating prism, e.g., a Schmidt-Pechan prism, is implemented within a fiber optic rotary joint (FORJ) to permit parallel transmission of a plurality of collimated optical fiber beams. In general, a Schmidt-Pechan prism also offers a number of advantages in the construction of a multiple channel FORJ. For example, the Schmidt-Pechan prism is completely reflective in nature, utilizing a combination of mirror reflections and total internal reflection and, as such, is insensitive to the wavelength of the optical signal that it transmits. Furthermore, a Schmidt-Pechan prism presents perpendicular faces to a collimated optical beam that is transmitted from an individual fiber (attached either to the stator or to the rotor) and, thus, the refraction of the beam, as the beam is transmitted through either surface of the prism, is zero, regardless of the index of refraction of the incident medium. It should be noted that certain surfaces of the Schmidt-Pechan prism reflect collimated beams via total internal reflection and, as such, the index of refraction of the prism material should be sufficiently high to permit total internal reflection at an interface between the prism material and the surrounding material.

Additionally, FORJs that implement a Schmidt-Pechan prism may include one or more cavities, between the prism and the fiber collimators, that may be filled with a pressure-compensating fluid, e.g., mineral oil. The Schmidt-Pechan prism is shorter, along the longitudinal axis, than either a Dove prism or an Abbe-Konig prism with identical area, inside which collimated beams may be de-rotated. Thus, the overall length of an FORJ may be reduced when a Schmidt-Pechan prism is implemented to de-rotate the optical beams.

According to another aspect of the present invention, the number of fiber optic channels for the FORJ may be readily increased by implementing gradient-index (GRIN) lens, e.g., a GRIN rod lens, of a specified diameter, whose lengths have been polished to less than a “quarter-pitch” (where a beam exiting an optical fiber located at one physical end of the lens is collimated to provide a planar wavefront at an opposing physical end of the lens). According to one aspect, the optical path length (removed on the fiber side of the lens) is replaced with an air gap spacing of appropriately determined length. According to another aspect, the optical path length (removed on the fiber side of the lens) is replaced with a pressure-compensating fluid-filled spacing of appropriately determined length. According to one aspect, the optical path length (removed on the fiber side of the lens) is replaced with a glass spacer of appropriately determined length. The shortened GRIN lens then has a longer effective focal length, which, in turn, permits collimation of a fiber optic beam over longer length and allows for the use of a longer de-rotating prism. This, in turn, allows for more area in which to locate the fiber optic collimators.

According to various embodiments of the present invention, an FORJ with a de-rotating prism is described herein that is capable of transmitting a plurality of optical signals across a rotating interface with reduced loss, as compared to prior art FORJs with de-rotating prisms. An FORJ, constructed according to the present invention, includes a stationary portion (hereinafter referred to as a stator housing), to which a plurality of fiber optic collimators are attached, a rotary portion (hereinafter referred to as a rotor housing), to which a plurality of fiber optic collimators are attached, and a portion coupled to the rotary portion by means of a 2:1 gearing ratio (hereinafter referred to as the prism housing), to which an Abbe-Konig de-rotating prism is attached.

In one embodiment, each fiber optic collimator includes an optical fiber and a collimating gradient index (GRIN) lens. The optical signal in an individual fiber attached to the rotor is collimated by a GRIN lens attached to the rotor. The optical signal is transmitted through the de-rotating prism such that the signal may be focused by a GRIN lens attached to an associated stator fiber. In this arrangement, the stator fiber, to which a signal from an individual rotor fiber is coupled, does not change and the optical signal strength is both substantially constant and relatively unattenuated over 360° rotation of the rotor. It should be appreciated that the FORJ is reciprocal in that the optical signal in an individual stator fiber may be collimated by an associated GRIN lens and transmitted through the de-rotating prism such that the signal may be focused by a GRIN lens attached to an associated rotor fiber. As above, the rotor fiber, to which a signal from an individual stator fiber transmits, does not change and the optical signal strength is substantially constant over 360° rotation of the rotor.

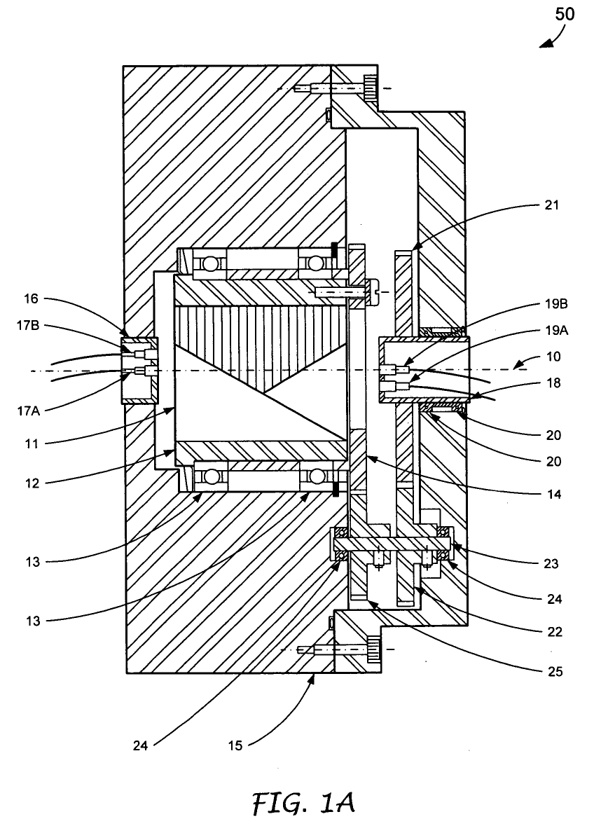

Referring to FIGS. 1A and 1B, a rotation axis 10 is defined passing longitudinally through fiber optic rotary joint (FORJ) 50 and 50A, respectively, constructed according to one embodiment of the present invention. An all-reflective de-rotating prism 11, e.g., an Abbe-Konig prism in FIG. 1A or a Schmidt-Pechan prism in FIG. 1B, is located in proximity to the rotation axis 10. The de-rotating prism 11 is attached to a de-rotating prism housing 12, which is rotatably attached to joint housing 15, for rotation about the rotation axis 10, by bearings 13. Also attached to the prism housing 12 is a primary prism gear 14. The de-rotating prism 11 is oriented such that a collimated optical beam (not shown) parallel to the rotation axis 10 that is incident upon the de-rotating prism 11 is transmitted through the prism 11 without lateral or angular deviation of the beam, regardless of the rotation angle of the de-rotating prism 11.

A stator collimator array 16, which is attached to the joint housing 15, is located on a first side of the de-rotating prism 11 along the rotation axis 10. The stator collimator array 16 includes a plurality of stator fiber optic collimators 17A and 17B arranged in a desired pattern, of which two are shown in FIG. 1. The stator fiber optic collimators 17A and 17B are arranged within the stator collimator array 16 in such a way that a collimated optical beam (not shown) exiting each of the stator fiber optic collimators 17A and 17B is parallel to the rotation axis 10.

A rotor collimator array 18 is located on a second side of the de-rotating prism 11, opposite the first side of the de-rotating prism 11, along the rotation axis 10. The rotor collimator array 18 includes a plurality of rotor fiber optic collimators 19A and 19B arranged in a desired pattern, which is a mirror reflection about one axis perpendicular to the rotation axis 10 of the pattern of the stator collimator array 16. It should be appreciated that more or less than two of the rotor fiber optic collimators 19A and 19B and stator fiber optic collimators 17A and 17B may be implemented. The rotor fiber optic collimators 19A and 19B are arranged within the rotor collimator array 18 so that a collimated optical beam (not shown) exiting each of the rotor fiber optic collimators 19A and 19B is parallel to the rotation axis 10. The rotor collimator array 18 is rotatably attached to the joint housing 15, by bearings 20, so as to freely rotate about the rotation axis 10. Also affixed to the rotor collimator array 18 is a primary rotor gear 21.

The rotor collimator array 18 is coupled to the de-rotating prism 11 by a secondary rotor gear 22, located within proximity to the primary rotor gear 21, such that rotation of the rotor collimator array 18, by an angle Q, causes a similar rotation of the primary rotor gear 21, by an angle Q. This, in turn, causes a rotation of the secondary rotor gear 22, by an angle −Q/2. Affixed to the secondary rotor gear 22 is a shaft 23, which is rotatably attached to the joint housing 15, by bearings 24. The shaft 23 is also affixed to a secondary prism gear 25. Rotation of the secondary rotor gear 22, by an angle −Q/2, causes a rotation of the secondary prism gear 25 of −Q. The secondary prism gear 25 is located in proximity to the primary prism gear 14 such that rotation of the secondary prism gear 25 of −Q causes a rotation of the primary prism gear 14 of Q/2. Thus, rotation of the rotor collimator array 18, by an angle Q, causes a rotation of the de-rotating prism 11, by an angle Q/2.

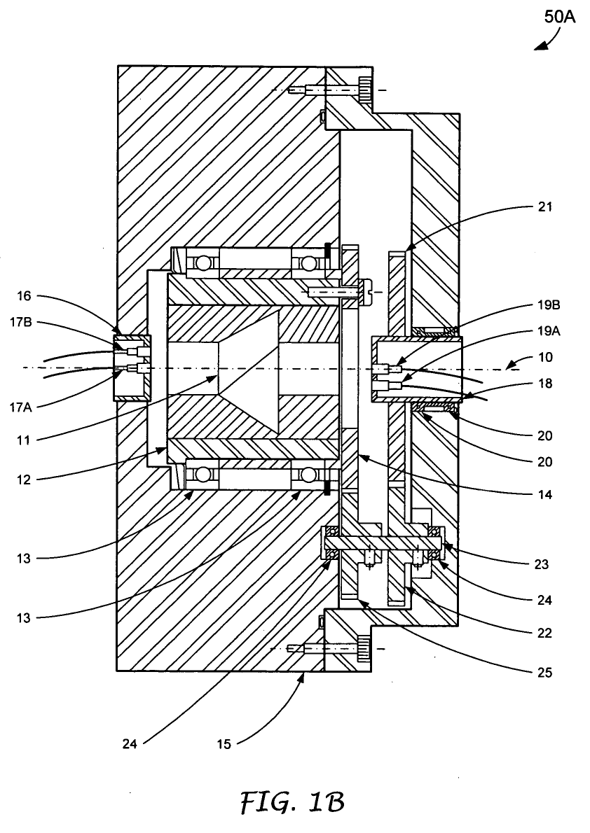

Referring to FIGS. 2A-2D and with reference to FIG. 1A, the arrangement of the stator fiber optic collimators 17A and 17B and the rotor fiber optic collimators 19A and 19B is such that the image of the stator collimator array 16 is transmitted through the Abbe-Konig de-rotating prism 11 in such a way that the image of each of the stator fiber optic collimators 17A and 17B coincide with the location of an individually associated one of the rotor fiber optic collimators 19A and 19B, regardless of the rotation angle Q of the rotor collimator array 18. This is due to the coupling of the rotation angle Q′ to a rotation angle 2Q′ of the rotor collimator array 18.

With specific reference to FIG. 2A, at 0° prism rotation, each of four stator fiber optic collimators (represented by a filled circle, an empty circle, a filled diamond and an empty diamond) are imaged, as shown, and the associated ones of the rotor fiber optic collimators 19A and 19B are oriented to correspond to the image of the stator fiber optic collimators 17A and 19B. With specific reference to FIG. 2B, at 90° prism rotation the image of the stator fiber optic collimators 17A and 17B has rotated by 180°. However, due to the 2:1 gearing mechanism, the rotor fiber optic collimators 19A and 19B have also rotated by 180° and, thus, continue to correspond to the image of the stator fiber optic collimators 17A and 17B. With reference to FIG. 2C, at 180° prism rotation the image of the stator fiber optic collimators 17A and 17B has rotated by 360°. However, due to the 2:1 gearing mechanism, the rotor fiber optic collimators 19A and 19B have also rotated by 360° and, thus, continue to correspond to the image of the stator fiber optic collimators 17A and 17B. With reference to FIG. 2D, at 270° prism rotation, the image of the stator fiber optic collimators 17A and 17B has rotated by 540°. Again, due to the 2:1 gearing mechanism, the rotor fiber optic collimators 19A and 19B have also rotated by 540° and, thus, continue to correspond to the image of the stator fiber optic collimators 17A and 17B. At 360° prism rotation, the optical system is equivalent to that shown for 0° prism rotation in FIG. 2A. It is to be appreciated that the de-rotating nature of the Schmidt-Pechan prism referenced in FIG. 1B is identical to that of the Abbe-Konig prism.

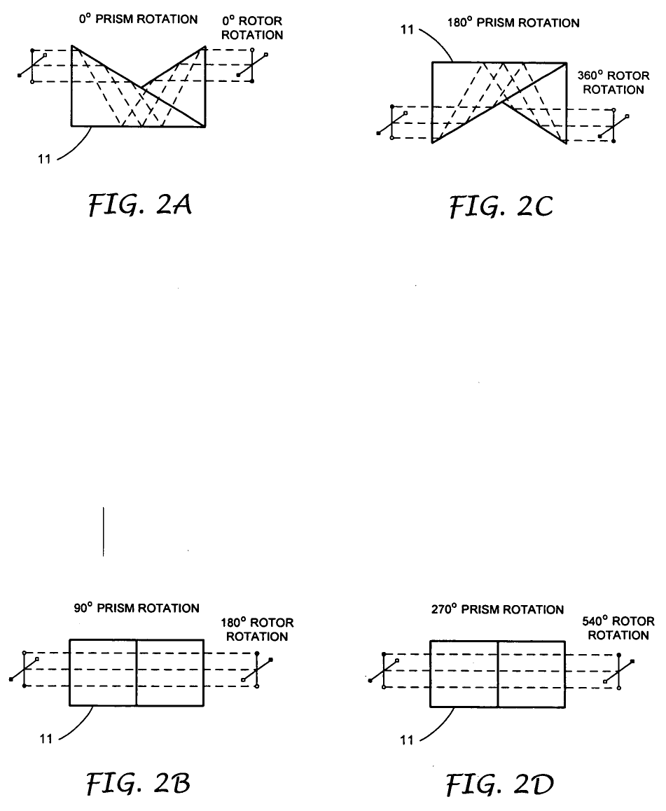

With reference to FIG. 3, in one embodiment, each of the stator fiber optic collimators 17A and 17B and each of the rotor fiber optic collimators 19A and 19B is defined by an assembly 40 that includes a gradient-index (GRIN) lens 26 (with a GRIN lens optical axis 26A passing longitudinally through the lens 26) and an optical fiber 27 (with an optical fiber central axis 27A) attached by, for example, optically transparent epoxy 28 to one planar end of the GRIN lens 26. The GRIN lens 26 may be selected to be equal to a “quarter-pitch” length, in order that a diverging Gaussian beam 29A originating (with infinite radius of curvature or equivalently planar wavefront) at an end of the optical fiber 27 is transformed into a collimated Gaussian beam 29B at an opposing planar end of the lens 26. That is, at the opposing end of the lens 26, the collimated Gaussian beam 29B also has an infinite radius of curvature or planar wavefront. The location of the end of the optical fiber 27 is coincident with the back focal point of the lens 26. The optical fiber central axis 27A may be aligned to be coincident with the GRIN lens optical axis 26A. In this manner, the collimated Gaussian beam 29B is centered and the collimated Gaussian beam propagates along the GRIN lens optical axis 26A.

Referring again to FIG. 1A, it will also be apparent that there exists a significant spacing between an individual one of the stator fiber optic collimators 17A and 17B and an associated one of the rotor fiber optic collimators 19A and 19B. Thus, the collimated Gaussian beam 29B that originates from an individual one of the stator fiber optic collimators 17A and 17B propagates over a relatively large distance to an associated one of the rotor fiber optic collimators 19A and 19B. Referring back to FIG. 3, during propagation of the beam 29B, the radius of curvature of the collimated Gaussian beam (shown as 29C in FIG. 3 at a representative distance from the GRIN lens 26) becomes less than infinite. Should the representative distance be equal to one-half the optical path distance between the individual stator fiber optic collimators 17A and 17B and the associated one of the rotor fiber optic collimators 19A and 19B, then the Gaussian beam will not have the correct curvature and size to be completely coupled into the optical fiber associated with the rotor fiber optic collimators 19A and 19B, which results in a relatively low transmitted signal strength.

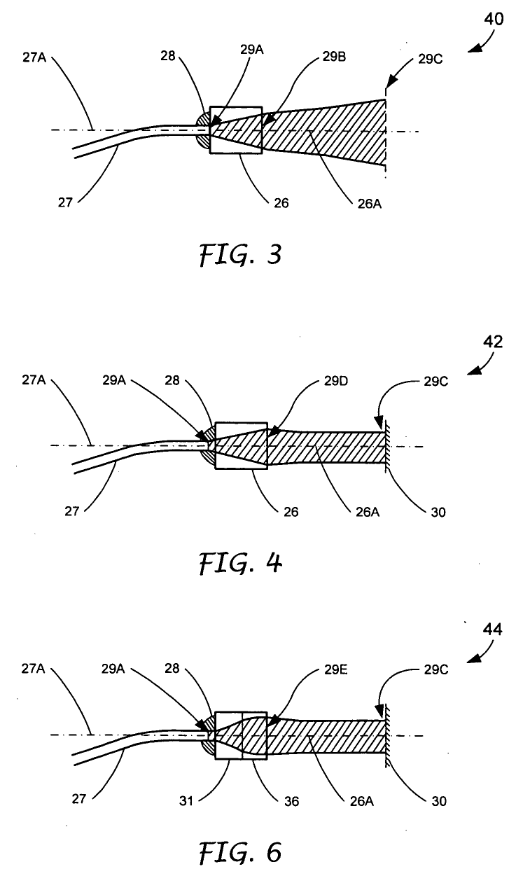

Referring to FIG. 4, an assembly 42 is illustrated with a GRIN lens 26 oriented a longitudinal distance from an alignment mirror 30, which is oriented perpendicular to the GRIN lens optical axis 26A. An optical fiber 27 with optical fiber central axis 27A is attached by means of optically transparent epoxy 28 in close proximity to one planar end of the GRIN lens 26. The proximity of the optical fiber 27 to the GRIN lens 26 is determined by optimizing the signal reflected from the alignment mirror 30 back into the optical fiber 27. The reflected signal may be measured by, for example, using a beam-splitter or 1×2 fiber optic coupler (not shown). The length of the GRIN lens 26 is equal to the “quarter-pitch” length in order that the diverging Gaussian beam 29A originating with infinite radius of curvature or equivalently planar wavefront at the end of the optical fiber 27 is transformed to a slightly convergent Gaussian beam 29D at the end of the GRIN lens 26 and transformed to a collimated Gaussian beam 29C at the location of the alignment mirror 30 when the back-reflected signal is optimized. That is, at the alignment mirror 30 location, the collimated Gaussian beam 29C also has infinite radius of curvature or equivalently planar wavefront.

In this embodiment, the location of the end of the optical fiber 27 is not coincident with the back focal point, but is rather located a small distance longitudinally further from the end of the GRIN lens 26 than the back focal point. The optical fiber central axis 26A is preferentially aligned in such a way as to be coincident with the GRIN lens optical axis 26A and so that the collimated Gaussian beam 29C propagates along the GRIN lens optical axis 26A. It should be appreciated that setting the longitudinal distance between the alignment mirror 30 and the GRIN lens 26 (along the GRIN lens optical axis 26A) to one-half of the total lens-to-lens optical path length between an individual one of the stator fiber optic collimators 17A and 17B and an associated one of the rotor fiber optic collimators 19A and 19B advantageously positions the location of the infinite radius of curvature of the collimated Gaussian beam 29C at one-half the optical path length. This, in turn, creates a symmetrical optical system with optimized transmitted signal strength.

As should be apparent to those skilled in the art of single-mode fiber optic collimators, the maximum longitudinal distance between the alignment mirror 30 and the GRIN lens 26, at which maximum back-reflected signal strength is achievable, is predicted by Gaussian beam optics formalisms, to be constrained by the wavelength-dependent characteristic size of the Gaussian beam 29A originating with infinite radius of curvature at the end of the optical fiber 27 and by the primarily length-dependent effective focal length of the GRIN lens 26. It should be appreciated that the maximum alignment mirror to GRIN lens distance is proportional to the square of the effective focal length of the GRIN lens, and that the effective focal length of the GRIN lens is inversely dependent upon the length of the GRIN lens. It should also be appreciated that the use of small diameter lenses in the present invention may be preferential to using larger diameter lenses in order to achieve as large a plurality of fiber optic channels as possible. The effective focal length of a SELFOC™ quarter-pitch GRIN lens is proportional to the diameter of the quarter-pitch GRIN lens. It is further to be appreciated that a required optical path length may not be achievable with optimum transmitted signal strength for a particular lens of small diameter with an associated effective focal length.

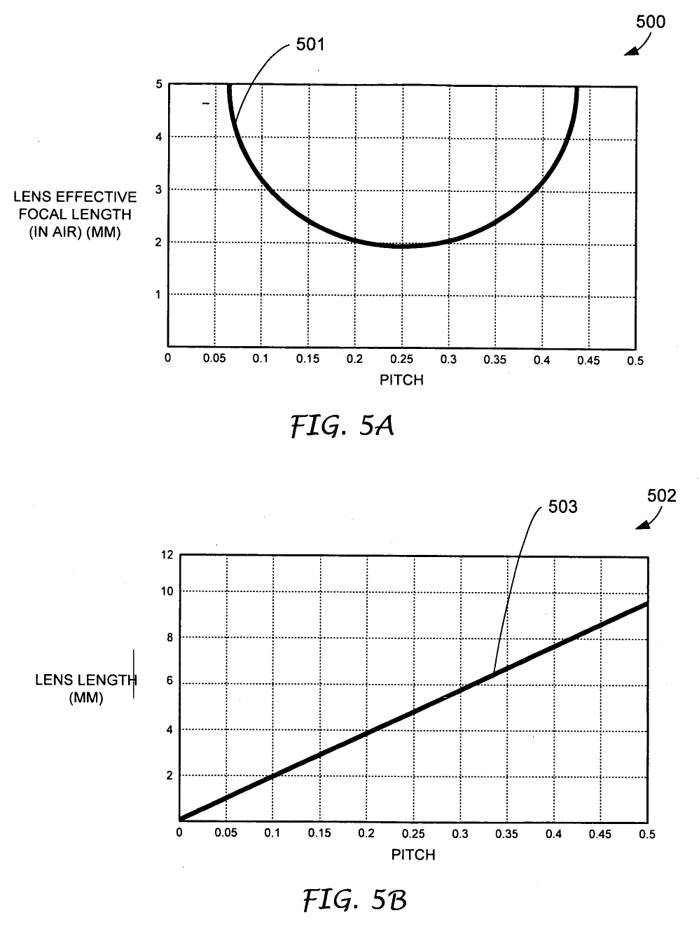

Referring to FIG. 5A, a graph 500 includes a curve 501 that depicts the relationship of the effective focal length to the pitch of a commercially available GRIN lens. Specifically the SLW-1.80 SELFOC™ lens supplied by Nippon Sheet Glass Company has an effective focal length that increases nonlinearly from a minimum at a pitch of 0.25 (“quarter-pitch”) by either increasing or decreasing the pitch of the lens. Referring to FIG. 5B, a graph 502 includes a curve 503 that depicts the relationship of the lens length to the pitch of the same commercially available GRIN lens of FIG. 5A. As is depicted by the graph 502, the lens length is linearly proportional to the pitch of the lens. From examination of the curves 501 and 503 of FIGS. 5A-5B, it should be apparent that increasing or decreasing the length of the lens serves to increase the effective focal length of the lens.

Referring to FIG. 5C, a graph 504 includes a curve 505 that depicts the relationship of the back focal length to the pitch of the same commercially available GRIN lens. As is shown, the focal length is non-linearly related to the lens pitch and becomes positive for lens pitch less than 0.25, negative for lens pitch greater than 0.25, and is zero for pitch equal to 0.25. It should be appreciated that increasing the length of the lens provides a larger effective focal length. However, the negative focal length implies that the preferred location for the optical fiber lies within the volume of the GRIN lens, which is mechanically impossible to achieve.

According to one aspect of the present invention, by reducing the length of the GRIN lens (and by definition reducing the pitch of the GRIN lens), the effective focal length is increased from a minimum at 0.25 pitch (see FIG. 5A) and the focal length is increased in a positive fashion from zero at 0.25 pitch (see FIG. 5C). It should be appreciated that the optical fiber may be affixed to the GRIN lens by a number of techniques, e.g., an optically transparent epoxy may be employed. However, the potentially large focal length created by shortening the GRIN lens may require a mechanically unstable large epoxy gap between the fiber and the GRIN lens. The GRIN lens may be separated from the fiber by an air gap of length approximately equal to the focal length of the shorter lens, or may be separated from the fiber by a pressure compensating fluid-filled gap approximately equal to the focal length of the shorter lens. In both aspects external means of attaching the GRIN lens to the fiber are required.

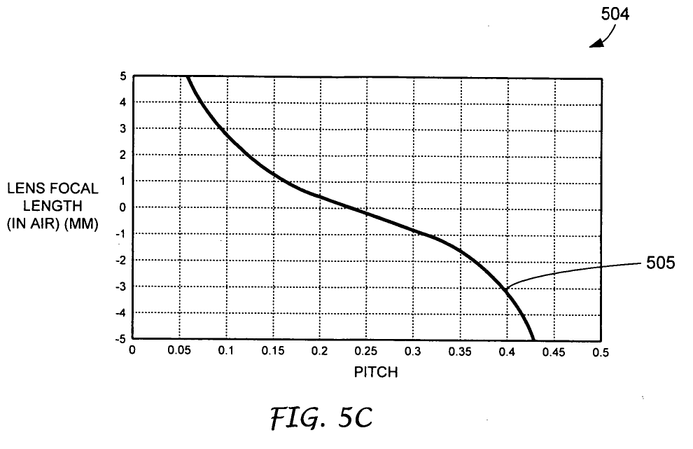

With reference to FIG. 6, according to one aspect of the present invention, a portion of the back focal length of the GRIN lens 36 is replaced with a glass spacer 31, which reduces the gap between an optical fiber 27 and the GRIN lens 36 and, thus, an epoxy 28 may be utilized to provide a mechanically stable connection. As is shown, an assembly 42 includes the GRIN lens 36, having a GRIN lens optical axis 26A that is affixed to the spacer 31. The spacer 31 has an optical path length equal to the back focal length of the GRIN lens 36 and is oriented a longitudinal distance from an alignment mirror 30, which is oriented perpendicular to the GRIN lens optical axis 26A. The optical fiber 27, having an optical fiber central axis 27A, is attached by an optically transparent epoxy 28 in close proximity to one planar end of the GRIN lens 36. The proximity of the optical fiber 27 to the GRIN lens 36 is determined by optimizing the signal reflected from the alignment mirror 30 back into the optical fiber 27. As above, the reflected signal may be measured by, for example, using a beam-splitter or a 1×2 fiber optic coupler.

According to one aspect of the present invention, the length of the GRIN lens 36 is selected to be less than a “quarter-pitch” length. This ensures that a diverging Gaussian beam 29A (with infinite radius of curvature) originating from an end of the optical fiber 27, which is attached in relative proximity to the GRIN lens 36/glass spacer 31 subassembly, is transformed to a slightly convergent Gaussian beam 29E at the end of the GRIN lens 36. The beam 29E is further transformed to a collimated Gaussian beam 29C, at the location of the alignment mirror 30, when the back-reflected signal is fully optimized. That is, at the alignment mirror 30 location, the collimated Gaussian beam 29C also has an infinite radius of curvature. The location of the end of the optical fiber 27 is not necessarily coincident with the back focal point of the GRIN lens 36, but is possibly located a small distance longitudinally further from the end of the glass spacer 31 than the back focal point. The location of the end of the optical fiber 27 is coincident with the back focal point of the GRIN lens 36 if the location of the alignment mirror 30 is coincident with the front focal point of the GRIN lens 36. The optical fiber central axis 27A is preferentially aligned in such a way as to be coincident with the GRIN lens optical axis 26A so that the collimated Gaussian beam 29C propagates along the GRIN lens optical axis 26A.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A multi-channel fiber optic rotary joint (FORJ), comprising:
an external housing containing an internal cavity having a longitudinal rotation axis;
a stationary collimator array fixed to the external housing approximate a first end of the internal cavity;
a rotating collimator array rotatably attached to the external housing approximate a second end of the cavity, wherein the second end of the cavity is opposite the first end of the cavity, and wherein the rotating collimator array is configured to rotate about the rotation axis;
an all-reflective de-rotating prism located along the rotation axis within the internal cavity between the stationary collimator array and the rotating collimator array, wherein the prism is retained in a prism housing that is rotatably attached to the external housing and the prism housing is configured to rotate about the rotation axis; and
a gear ratio rotatably attached to the external housing, wherein the gear ratio causes the prism housing to rotate at a rate that is one-half a rotation rate of the rotating collimator array.

2. The FORJ of claim 1, wherein the internal cavity is filled with a liquid medium to provide for pressure compensation.

3. The FORJ of claim 1, wherein the stationary collimator array and the rotating collimator array each includes a plurality of fiber optic collimator assemblies arranged in a pattern in a plane transverse to the rotation axis, and wherein each of the assemblies includes an optical fiber located parallel to and coincident with an optical axis of a collimating lens near the focal plane of the collimating lens, where the optical axis of the collimating lens is oriented parallel to the rotation axis.

4. The FORJ of claim 3, wherein the de-rotating prism includes a 30°-60°-90° prism attached to a 60° equilateral prism to provide an Abbe-Konig prism or the de-rotating prism includes a 45°-135°-67.5°-112.5° prism attached to a 45°-67.5°-67.5° prism to provide a Schmidt-Pechan prism.

5. The FORJ of claim 4, wherein components of the de-rotating prism are made of the same material.

6. The FORJ of claim 4, wherein opposed end surfaces of the de-rotating prism are oriented at orthogonal angles to the rotation axis to present an optically flat surface at normal incidence to collimated beams provided by the fiber optic collimator assemblies.

7. The FORJ of claim 6, wherein de-rotation of the collimated beams is solely achieved by reflection and deviation of the collimated beams after transmission through the de-rotating prism is not affected by a medium filling the internal cavity.

8. The FORJ of claim 4, wherein the fiber optic collimator assemblies each includes a quarter-pitch gradient-index (GRIN) lens with a defined optical axis to which is affixed the optical fiber with a defined central axis coincident to the optical axis of the GRIN lens and with an end face of the optical fiber located longitudinally in proximity to the GRIN lens for collimating a Gaussian beam diverging from the end face of the optical fiber to have planar wavefront one-half of the optical path length between an individual one of the stator fiber optic collimator assemblies and an associated individual one of the rotor fiber optic collimator assemblies.

9. The FORJ of claim 4, wherein the fiber optic collimator assemblies include a gradient-index (GRIN) lens polished to shorter than a quarter-pitch to which is attached a glass spacer with a length selected to have an optical path length that is equal to a back focal length of the GRIN lens, with a defined optical axis to which is affixed the optical fiber with a defined central axis coincident to the optical axis of the GRIN lens and with an end face of the optical fiber located longitudinally in proximity to the GRIN lens for collimating a Gaussian beam diverging from the end face of the optical fiber to have planar wavefront one-half of the optical path length between an individual one of the stator fiber optic collimator assemblies and an associated individual one of the rotor fiber optic collimator assemblies.

10. A multi-channel fiber optic rotary joint (FORJ), comprising:
an external housing containing an internal cavity having a longitudinal rotation axis;
a stationary collimator array fixed to the external housing approximate a first end of the internal cavity;
a rotating collimator array rotatably attached to the external housing approximate a second end of the cavity, wherein the second end of the cavity is opposite the first end of the cavity, and wherein the rotating collimator array is configured to rotate about the rotation axis;
a de-rotating prism located along the rotation axis within the internal cavity between the stationary collimator array and the rotating collimator array, wherein the prism is retained in a prism housing that is rotatably attached to the external housing and the prism housing is configured to rotate about the rotation axis; and
a gear ratio rotatably attached to the external housing, wherein the gear ratio causes the prism housing to rotate at a rate that is one-half a rotation rate of the rotating collimator array, wherein the internal cavity is filled with a liquid medium to provide for pressure compensation.

11. The FORJ of claim 10, wherein the stationary collimator array and the rotating collimator array each includes a plurality of fiber optic collimator assemblies arranged in a pattern in a plane transverse to the rotation axis, and wherein each of the assemblies includes an optical fiber located parallel to and coincident with an optical axis of a collimating lens near the focal plane of the collimating lens, where the optical axis of the collimating lens is oriented parallel to the rotation axis.

12. The FORJ of claim 10, wherein the de-rotating prism includes a 30°-60°-90° prism attached to a 60° equilateral prism to provide an Abbe-Konig prism or the de-rotating prism includes a 45°-135°-67.5°-112.5° prism attached to a 45°-67.5°-67.5° prism to provide a Schmidt-Pechan prism.

13. The FORJ of claim 12, wherein components of the de-rotating prism are made of the same material.

14. The FORJ of claim 12, wherein opposed end surfaces of the de-rotating prism are oriented at orthogonal angles to the rotation axis to present an optically flat surface at normal incidence to collimated beams provided by the fiber optic collimator assemblies.

15. The FORJ of claim 14, wherein de-rotation of the collimated beams is solely achieved by reflection and deviation of the collimated beams after transmission through the de-rotating prism is not affected by the medium filling the internal cavity.

16. The FORJ of claim 11, wherein the fiber optic collimator assemblies each includes a quarter-pitch gradient-index (GRIN) lens with a defined optical axis to which is affixed the optical fiber with a defined central axis coincident to the optical axis of the GRIN lens and with an end face of the optical fiber located longitudinally in proximity to the GRIN lens for collimating a Gaussian beam diverging from the end face of the optical fiber to have a planar wavefront one-half of the optical path length between an individual one of the stator fiber optic collimator assemblies and an associated individual one of the rotor fiber optic collimator assemblies.

17. The FORJ of claim 11, wherein the fiber optic collimator assemblies include a gradient-index (GRIN) lens polished to shorter than a quarter-pitch to which is attached a glass spacer with a length selected to have an optical path length that is equal to a back focal length of the GRIN lens, with a defined optical axis to which is affixed to the optical fiber with a defined central axis coincident to the optical axis of the GRIN lens and with an end face of the optical fiber located longitudinally in proximity to the GRIN lens for collimating a Gaussian beam diverging from the end face of the optical fiber to have a planar wavefront one-half of the optical path length between an individual one of the stator fiber optic collimator assemblies and an associated individual one of the rotor fiber optic collimator assemblies.

18. A multi-channel fiber optic rotary joint (FORJ), comprising:
an external housing containing an internal cavity having a longitudinal rotation axis;
a stationary collimator array fixed to the external housing approximate a first end of the internal cavity;
a rotating collimator array rotatably attached to the external housing approximate a second end of the cavity, wherein the second end of the cavity is opposite the first end of the cavity, and wherein the rotating collimator array is configured to rotate about the rotation axis;
an Abbe-Konig prism located along the rotation axis within the internal cavity between the stationary collimator array and the rotating collimator array, wherein the prism is retained in a prism housing that is rotatably attached to the external housing and the prism housing is configured to rotate about the rotation axis; and
a gear ratio rotatably attached to the external housing, wherein the gear ratio causes the prism housing to rotate at a rate that is one-half a rotation rate of the rotating collimator array.

19. The FORJ of claim 18, wherein the internal cavity is filled with a liquid medium to provide for pressure compensation.

20. The FORJ of claim 18, wherein the stationary collimator array and the rotating collimator array each includes a plurality of fiber optic collimator assemblies arranged in a pattern in a plane transverse to the rotation axis, and wherein each of the assemblies includes an optical fiber located parallel to and coincident with an optical axis of a collimating lens near the focal plane of the collimating lens, where the optical axis of the collimating lens is oriented parallel to the rotation axis.

21. The FORJ of claim 20, wherein the fiber optic collimator assemblies include a gradient-index (GRIN) lens polished to shorter than a quarter-pitch to which is attached a glass spacer with a length selected to have an optical path length that is equal to a back focal length of the GRIN lens, with a defined optical axis to which is affixed the optical fiber with a defined central axis coincident to the optical axis of the GRIN lens and with an end face of the optical fiber located longitudinally in proximity to the GRIN lens for collimating a Gaussian beam diverging from the end face of the optical fiber to have planar wavefront one-half of the optical path length between an individual one of the stator fiber optic collimator assemblies and an associated individual one of the rotor fiber optic collimator assemblies.
